(19) United States
(12) Patent Application Publication
(10) Pub. No.: US 2011/0112672 A1
(43) Pub. Date: May 12, 2011

(54) Systems and Methods of Constructing a Library of Audio Segments of a Song and an Interface for Generating a User-Defined Rendition of the Song

(75) Inventors: Jeffrey Richard Brown, John's Creek, GA (US); William Grant Pike, JR., Atlanta, GA (US)

(73) Assignee: Fried Green Apps, Norcross, GA (US)

(21) Appl. No.: 12/944,542

(22) Filed: Nov. 11, 2010

Related U.S. Application Data
(60) Provisional application No. 61/260,385, filed on Nov. 11, 2009.

(51) Int. Cl. G06F 17/00

(52) U.S. Cl. 700/94

(57) ABSTRACT

A library of audio segments of a song is generated by receiving recorded tracks that include a complete performance of or a composition of unique portions and repetitive portions of the song, segmenting a select track into intervals, analyzing each interval to characterize the interval, comparing each interval with subsequent intervals of the select track to identify repetitive content in the song, identifying a select interval from a set of repeated intervals from the select track and storing the encoded representation of each of the select intervals from a corresponding set of repeated intervals in the library. Intervals can be characterized by frequency analysis, cross-correlation of a waveform, by a trained ear or by analysis of a musical notation corresponding to the song. Intervals for compression can be based on beats, that is, the time for a designated note, notes, a measure, or multiple measures. One or more unique measures can be encoded for additional compression. An interface exposes information from the library that enables the user to control a rendition of the song.

### BACKGROUND

Conventional audio recordings, and, more particularly music recordings, are commercially distributed in a predefined and substantially unalterable stereophonic (“stereo”) format. Typically, original “master” audio tracks (e.g., a vocal track, a lead guitar track, a bass guitar track and a drum track) that were recorded in a music studio and, thereafter, mixed by an audio engineer were fixed on one or more of a vinyl disc (LP record), an audio cassette, on a compact disc (“CD”), and more recently, DVD, DVD-audio, SACD or other media format for commercial distribution, collectively “playable media.”

As used herein, a “master track” refers, generally, to one or more of a single recording instance. For example, a singer who is recording a song may sing the song once, referred to generally as a “take,” into a microphone and the “take” is recorded. The singer then sings the song again, thereby recording a second take. After several takes are recorded, a single take is isolated, or takes are combined, and a master track is created the several takes. Typically, a master track is recorded so that playback of the track occurs on at least one audio channel, e.g., a left or a right channel in a stereophonic recording. This process is commonly referred to in the art as “panning.”

An audio channel (or, simply, “channel”) refers, generally, to a mechanism providing a single path in a multi-path system for simultaneously and separately recording or transmitting sounds from a single source. A master track is, typically, mixed with other master tracks and played on at least one single channel (e.g., the left stereo channel). A single channel may, in some instances, play only a single master track. More typically, a single channel plays a plurality of master tracks representing one or more voices, one or more instruments or combinations thereof, that are combined or blended (referred to herein, generally, as “mixed”) together. In other cases, a single master track, such as a lead vocal track, is formatted to play over two channels.

In a prior art stereo audio recording, master audio tracks are mixed to play over two channels, i.e., the left channel and right channel. Thus, in a stereo system, each channel is made up of one or more master tracks. The master tracks cannot be re-mixed by a purchaser of the playable media, i.e., the compact disc, cassette, vinyl LP or the like. Although the individual master tracks and individual takes are usually saved, for example, in a recording studio's archives, they are not made available to the general public for re-mixing.

Home multi-track recording has been available for a considerable amount of time. Multi-track recorders have included equipment for recording multiple audio tracks on reel-to-reel tape, cassette tape, and digital media, including hard disks, compact discs and recordable DVDs, for example.

Relatively recently, multi-track digital recording software applications have been developed, and are now commercially available at affordable prices. For example CAKEWALK, BAND-IN-A-BOX, N-TRACK STUDIO, POWERTRACKS PRO AUDIO, PRO-TOOLS or the like available from the known suppliers have enabled people to make multi-track digital recordings using personal computers.

Home multi-track recording, especially in a digital form, is a cost-effective and useful way for musicians to record and distribute their music without the overhead of a professional quality recording studio. Typically, musicians who wish to distribute their music use multi-track recording systems to record master audio tracks. The musicians may function as audio engineers, or, alternatively, hire audio engineers to mix the master tracks in order to create a finished, stereo recording of their music. Thereafter, the stereo recording is transferred (referred to in the art as “burned”) to a compact disc or other playable media for eventual distribution.

FIG. 1 shows an example prior art playable media commonly referred to as an audio compact disc 10 (CD) that has a stereo recording having a left stereo channel 12 and a right stereo channel 14. As shown in FIG. 1, master tracks 1, 2 and 3, for example, having lead guitar, vocals and drums, are mixed to play on the left stereo channel 12, and master tracks 4, 5 and 6, for example, having rhythm guitar, vocals and keyboard, are mixed to play on the right stereo channel 14.

Typically, master audio tracks that are recorded in a native digital multi-track recording application (e.g., “CAKEWALK”) are formatted in one or more digital audio files, for example, formatted as AIFF, WAV, PCM, and/or RIFF files, which are usually uncompressed and, typically, large in size. A multi-track audio recording having, for example, sixteen master tracks typically includes sixteen separate audio files (e.g., WAV files), wherein one file contains a single track. Furthermore, digital multi-track recording software applications use one or more additional files, sometimes referred to as project files, which include information regarding combing the master tracks according to a predetermined mix, and then for manipulating the levels of each respective track, for example, to adjust volume, special effects, or the like.

Musicians, who distribute their music on an audio CD or the like, typically do not distribute each individual master track to consumers for various reasons. One reason is that the recipient of a digital multi-track recording typically will require the multi-track recording software application that was originally used to record or mix the tracks in order to play the recording. The recipient may also require additional information files, such as project files, to play the multi-track recording. Another reason is that original multi-track digital recordings are typically very large in size, requiring many hundreds of megabytes or even gigabytes of space per individual song. This makes it impractical to distribute many songs, each having a size of several hundreds of megabytes, to a large number of people. Thus, commercial distribution of audio recordings, particularly music recordings, continues in a pre-mixed stereo version that, albeit considerably smaller in size, lacks features for manipulating individual master tracks for custom mixing operations.

FIG. 2 shows a known digital video disc format 20 (DVD) that includes a multi-channel soundtrack commonly referred to as 5.1, AC-3 or DOLBY DIGITAL surround sound audio compression. The audio compression encodes a range of audio channels into a bit stream. As shown in the example DVD of FIG. 2, six channels are provided that include a left channel, a center channel, a right channel, a left-surround channel, a right-surround channel, and a sixth channel that provides bass information (providing frequencies of up to 150 Hz), known as a low frequency effect channel, or LFE. It is known that for frequencies of up 150 Hz, i.e., bass tones, the source or location of the bass tones cannot be detected by human listeners.

Conventional amplifiers provide one mechanism for listeners to adjust a pre-mixed soundtrack. These conventional amplifiers include band-pass filters that permit sounds within a range of frequencies to pass to an input of a corresponding audio amplifier. Each of the separate audio amplifiers operates in accordance with a control signal coupled to the respective amplifier circuit. While these conventional amplifiers enable a listener to emphasize or deemphasize sounds in a previously mixed audio recording, the listener is unable to discriminate or otherwise adjust the playback of a single track within the pre-recorded information.

As technology directed to music distribution and enhancing the audio listening experience continues to evolve, new patterns have started to form. For example, people download stereo music in encoded formats. This downloaded music can be stored on personal computers and shared across a host of playback devices configured to process or decode the encoded storage formats. However, songs stored in these encoded formats have been “mixed” and cannot be remixed by a holder of the previously encoded song.

U.S. Pat. No. 7,343,210 describes an interactive digital medium and a system that provides user access to individual master tracks and/or channels that make up the recording. The interactive digital medium includes a pre-mixed stereo recording as well as additional recorded information. The selection of a “custom mix” option by the listener instructs the system to expose the individual master tracks or channels. The master tracks can be manipulated by adjusting the volume and or adding special effects to each of the separate tracks. The disclosed interactive digital medium is limited to about five discrete master tracks in addition to the pre-recorded stereo mix. However, it is not uncommon for a musical recording to include many more instruments, vocalists, etc. than could be individually recorded in five separate and distinct master tracks and added to a medium along with a pre-mixed stereo version of the audio recording.

Data compression is widely used to reduce the amount of data required to process, transmit, store and/or retrieve a given quantity of information. Data compression techniques have been widely deployed to compress a sampled audio files including music.

Existing lossy audio compression techniques such as MP3,WMA and Ogg Vorbis, for example, demonstrate success in providing compression ratios which successfully reduce the size of a data file of sampled audio. These techniques employ psychoacoustic models and traditional statistical coding techniques to achieve data reduction.

Cunningham and Grout (2006) provide an overview of advances in similarity-based audio compression techniques of sampled recordings. They conclude that the most likely technique to provide the most acceptable results to a listener will be a frequency/time based transform. They recognize that music contains inherent repetition. In particular many musical styles such as techno, electronic, hip-hop, etc. rely heavily on the frequent repetition of beats, hooks, riffs and vocals. They believe that the key to achieving practical usage of any frequency/time based transform in the identification of similarity in a sampled file is a need to optimize the block size of samples used in the comparison analysis. However, Cunningham and Grout are trying to identify similarities in the frequency spectrum of a pre-recorded and mixed combination of multiple master tracks, i.e., the entire mixed and produced version of a pre-recorded song. Moreover, Cunningham and Grout propose to compare sampled music at any sample rate, bit-depth, and across multiple channels. The task of comparing such complex waveforms and identifying potential matches is formidable if not unmanageable even with present storage capacities and computing capabilities.

U.S. Patent Application Publication 2006/0173692 to Rao et al. describes a system, apparatus and a method for compressing audio by detecting and processing repetitive structures in the audio. The input audio signal may reside in various data collections accessible via a computer based communications network, such as the Internet. The system includes a repetition detector that is configured to detect repetitive structures in audio signals or files. The repetition detector generates repetition data, which is forwarded to an encoder for compression. The system can further include a beat tracking detector to increase the efficiency of the repetition detector. An audio compression method can include the step of detecting structurally redundant data in portions of an audio signal or file that have similarly repetitive content, generating repetition data for the detected structurally redundant data, and then encoding an audio file using the generated repetition data. The detecting step includes constructing a similarity matrix of at least one feature vector to parameterize equal length analysis windows. The detection of points of significant change provides for the extraction of segment boundaries, such as individual note boundaries and natural segment boundaries such as verse/chorus transitions within the audio file. The system and method described by Rao et al. processes an audio file that contains a pre-recorded and mixed combination of multiple master tracks, i.e., the entire mixed and produced version of a pre-recorded song.

### SUMMARY

Various embodiments, aspects and features of the present invention encompass a method for collecting audio segments into a library and an interface for enabling a user to select and modify the audio segments from the library to generate a user-defined rendition of a song.

An embodiment of a method for constructing a library of audio segments of a song, includes the steps of receiving M tracks of a song, the M tracks including a recording of a select performer of the song, selecting one of the M tracks to generate a select track for analysis, segmenting the select track into intervals, the song containing a series of the intervals, analyzing a characteristic of each interval of the select track to characterize each interval, comparing each interval with subsequent intervals of the select track to identify repetitive intervals, identifying a select interval from a set of repeated intervals from the select track and storing the select interval from a corresponding set of repeated intervals in the library.

An embodiment of a system includes a processor and a memory coupled to the processor via a local interface. The processor can access a number of tracks of a performed song, the tracks including a recording of a select performer. The memory includes sets of executable instructions. A first set of executable instructions, when executed by the processor, direct the system to segment a select track from the set of tracks of the performed song into intervals. A second set of executable instructions, when executed by the processor, direct the system to characterize each interval of the select track by analyzing a characteristic within each interval. A third set of executable instructions, when executed by the processor, directs the system to compare each interval of the select track with subsequent intervals from the select track to identify repetitive content. A fourth set of executable instructions, when executed by the processor, identifies a portion of the select track with repetitive content, which is stored in a library and available for replay.

An embodiment of an interface includes a processor and a memory in communication with the processor. The processor can access a library of select measures from sets of repeated measures in M tracks of a recorded performance of a song, wherein each of the M tracks includes a recording of a select performer. The memory includes a control store and a set of executable instructions. The control store includes information associated with one or more user selectable parameters. The set of executable instructions, when executed by the processor, directs the interface to generate and adjust a sequence from the library information representing the unique measures and the select measures from the sets of repeated measures in a subset of the M tracks of the recorded song in accordance with the one or more operator selectable parameters to generate a user-defined rendition of the song.

### BRIEF DESCRIPTION OF THE DRAWINGS

The systems and methods for constructing a library of audio segments of a song and the interface for generating a user-defined rendition of the song can be better understood with reference to the following figures. The components within the figures are not necessarily to scale, emphasis instead being placed upon clearly illustrating the principles of constructing the library and enabling a listener to generate a custom rendition of a song. Moreover, in the figures, like reference numerals designate corresponding parts throughout the different views.

FIG. 1 is a schematic diagram illustrating an embodiment of a conventional audio compact disc.

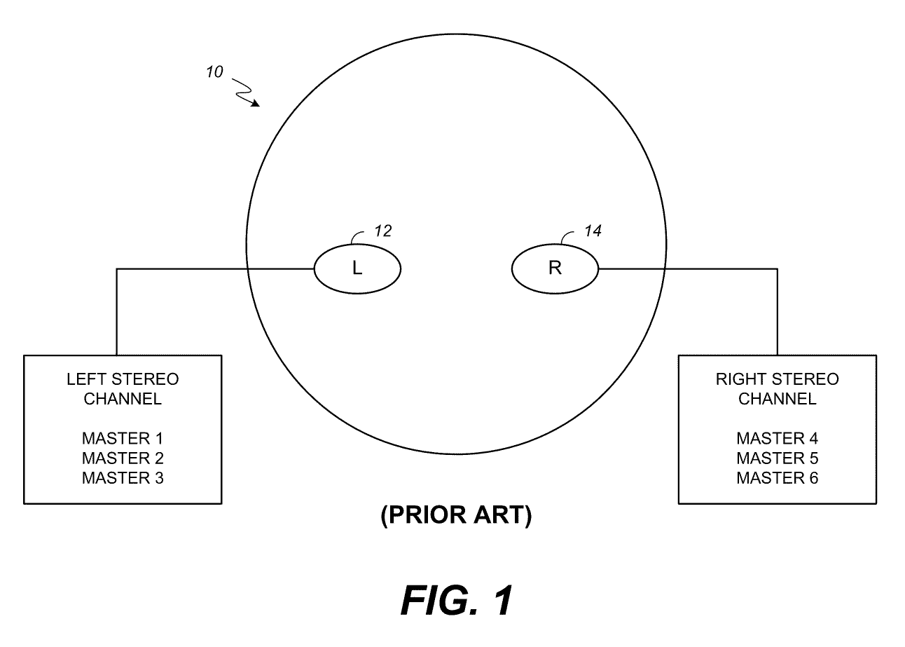

FIG. 2 is a schematic diagram illustrating an embodiment of a conventional digital video disc including surround, center, and low frequency effect audio channels in additional to left and right audio channels.

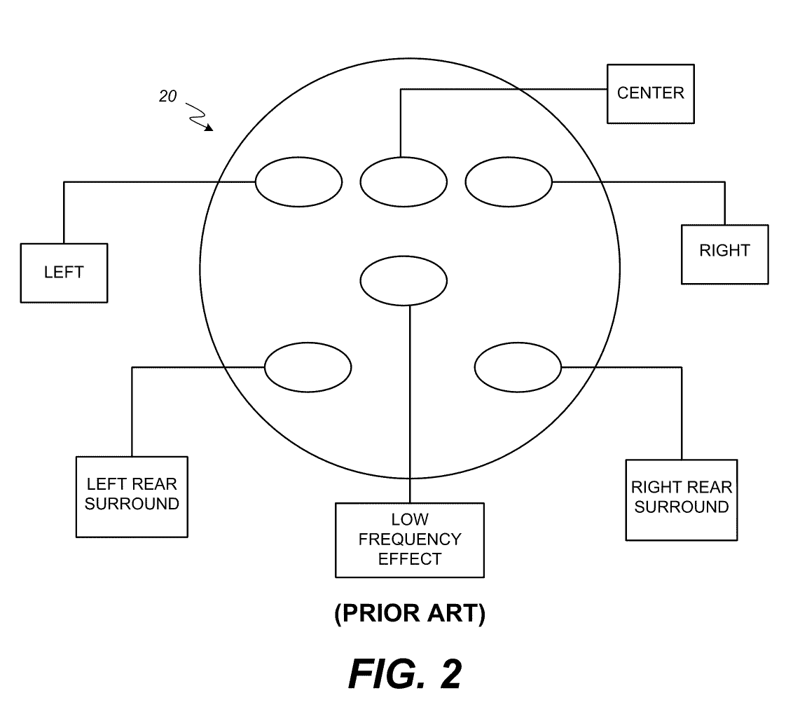

FIG. 3 is a flow diagram illustrating an embodiment of a method for enabling users to create a user-defined rendition of a song.

FIG. 4 is a flow diagram illustrating a method for constructing a library of pre-recorded audio segments of a song.

FIG. 5 is a schematic diagram illustrating an embodiment of an audio compression system.

FIG. 6 is a schematic diagram illustrating an embodiment of an interface.

FIG. 7 is a schematic diagram illustrating the operation of an embodiment of the audio segmenter of FIG. 5.

FIG. 8 is a schematic diagram illustrating an embodiment of a frequency spectrum of a segment of a measure from a select track.

FIG. 9 is a schematic diagram illustrating the operation of an embodiment of the cross-correlator of FIG. 5.

FIG. 10 is a schematic diagram illustrating the operation of an embodiment of the sequencer of FIG. 5.

### DETAILED DESCRIPTION

Embodiments and aspects of the present systems and methods provide a solution to the above-described need in the art, as well as other needs in the art by generating and exposing a library of digitally sampled intervals of a song to a user. An audio compression system receives a set of sampled tracks from the performance of a song. Tracks are recorded for each performer. The tracks may include a complete performance of the song. Alternatively, the tracks may include a composition of unique portions of the song along with a single performance of repetitive portions of the song. Songs can be performed by desired combinations of performers typically associated with a particular musical genre. In addition, separate performance tracks can be pre-recorded for non-typical instruments for the particular genre.

The audio compression system, analyzes each track by subdividing the respective tracks into sub-intervals of a measure. Sub-intervals can be identified by frequency analysis, cross-correlation of the frequency results, a trained ear, or by reading the musical notation that was used by the performer of the song, among others. However the sub-intervals are identified, information defining or characterizing the content within the sub-intervals is compiled on a measure by measure basis, to identify measures with repetitive content. When a repetitive measure has been identified, for example when a particular instrument plays the same set of notes with the same timing in at least two distinct portions of the performance, a single instance of the repetitive measure is selected based on magnitude and relative timing within the measure. The select single instance is identified at the appropriate measure positions within the song by a sequencer that generates a series sequence of the measures of the song. Alternatively, one familiar with the song, or how to read the musical notation (i.e., sheet music) in a particular arrangement of the song, can identify a portion of the song that is repeated by the performer associated with a particular track. When this is the case, the performer may be asked to perform a repetitive measure or measures for recording rather than the entire song. Individual notes, chords, measures or multiple measures are digitally sampled and stored to create a digital representation of the corresponding portions of the provided track. Unique measures and the select single instance of a repetitive measure is stored in the library. Each of the multiple tracks from a performance of a song or portions thereof can be similarly processed by the audio compression system to generate a set of digitally sampled and stored tracks that contain all the information available when the track was performed. By storing unique portions and a single instance of repeated portions of each track along with sequence information for each track, the library provides multiple tracks of a song performed under multiple genres to a listener.

The library includes audio segments performed by musicians and singers stored in a novel way. As described above, a collection of instruments and musicians is selected to perform a song or portions of a song in accordance with a particular genre or musical style. It is contemplated that most songs in the library will be performed, stored and made available in multiple genres. Any number of desired instruments and musicians can be selected for a particular song and genre combination. Each performer is associated with a track. Each performance is separately recorded and digitally sampled. Audio segments including unique measures (or portions of measures) and a select single instance of a repetitive measure (or a portion of a measure) from each performance are identified, digitally sampled and stored in the library. As explained above, a recorded performance may include an entire performance of a song or simply the recorded unique portions and repeated portions that when replayed in the proper sequence, generate the song. However performed and recorded, audio segments in the library are identified by title, genre, instrument/performer/track, and a sequence identifier among other possible identifiers.

It has been observed that musicians will often emphasize a particular verse or refrain of a song by performing slightly louder or slightly faster than other portions of the song. Accordingly, when recreating a track from the unique portions and the select single instance of repetitive portions of a song, manipulation of one or more audio effects when replaying a select instance of a repetitive portion for the second or any subsequent time or for a collection of repetitive portions during a particular verse or refrain can give the impression to a listener that the “temporally compressed” track is a performance of the entire song. Tempo and volume adjustments are representative of manipulations that can be controlled or otherwise introduced by a musician performing the song. Once sampled and digitized the various segments of the select track stored in the library can be adjusted using other audio effects.

An interface, with access to the library and sequence information that can be used to recreate the originally recorded tracks in their entirety is provided to an operator. The interface includes controls for selecting a song, a genre, and which of the digitally sampled and stored tracks to include in a rendition of the song. The selection of a particular genre can result in the automatic inclusion of a set of tracks generated for that particular genre. For example, if the operator selects a rock and roll version of the song, stored temporally compressed tracks including audio segments recorded by one or more percussionists, an electric guitar, a bass guitar, and an electronic keyboard may be automatically selected. Other collections of instruments may be associated with the selection of a different genre. Each of the automatically selected tracks can be excluded from the rendition of the song as may be desired by corresponding controls for excluding a track.

In addition to these controls, the interface provides additional controls for separately adjusting the multiple tracks. For example, an operator of the system can choose to adjust the pitch, relative timing, volume, reverb or any other audio effect. Example additional audio effects may include but are not limited to changing the spatial relationships of one or more of the performers (i.e., three-dimensional positioning), or adjusting one or more of timbre, chorus, distortion or other vocal effects. For example, during the course of the operator rendered version of the song, a vocalist whose voice in the recording was reproduced at the center of the soundstage can be moved to sound as if the vocalist had walked to the left side of the soundstage. Thereafter, the vocalist can be moved to give the impression that the vocalist has moved to the right side of the soundstage.

Example embodiments disclosed in conjunction with the following description include a library of audio segments. As described briefly above, the library includes audio segments that have been temporally compressed by selecting at least one audio segment with repetitive content and indexing the at least one audio segment for insertion in a sequence of audio segments that in the composite identify a track. Thus, a temporally compressed track includes a combination of unique audio segments and the at least one audio segment with repetitive content. The library includes any number of temporally compressed tracks (i.e., representations of performances of a song) that can be selected and manipulated to generate a rendition of a song. The audio segments of the temporally compressed tracks are stored in a digitally sampled format absent additional encoding or formatting. In addition, the audio segments of the temporally compressed tracks can be copied and encoded in one or more formats compatible with known or future developed audio encoders.

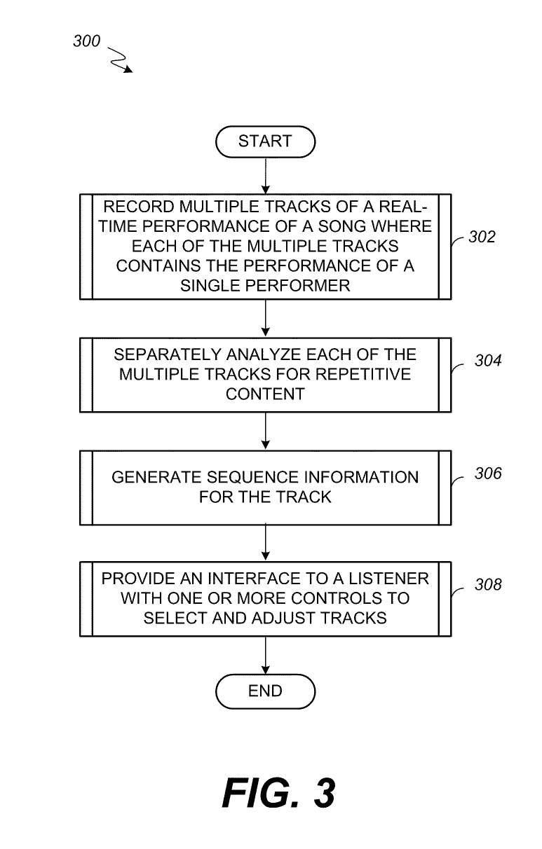

Turning now to the drawings, wherein like reference numerals designate corresponding parts throughout the drawings, reference is made to FIG. 3, which illustrates a flow diagram of an embodiment of a method 300 for enabling a user of an interface to generate a custom rendition of a song. Several of the steps illustrated in the flow diagram of FIG. 3 show the functionality and operation of an audio processing system that generates a library of digitally sampled audio tracks and an interface that provides controls that enable a listener to generate a custom rendition of the song. In this regard, each block represents a module, segment, or portion of code, which comprises one or more executable instructions for implementing the specified function(s).

The method 300 begins with block 302 where multiple tracks of a performance of a song are recorded. Each of the multiple tracks contains the performance of a single performer of the song. For example, a first track includes a performance of the song by a lead vocalist, a second track includes a performance of the song by a back up vocalist, a third track includes a performance of the song by a piano player, and so on. It is desired to provide a user/listener with access to separate performances of a particular song. In an embodiment, it is further desired to provide a collection of tracks of a performance of a song in a desired genre. As described above, each of the M tracks may include a complete performance of the song or a performance of the unique portions of the song from the contributing performer along with a single performance of portions of the song that are repeated.

Some treat the terms genre and style as the same, and state that genre should be defined as pieces of music that share a certain style or the same “musical language.” Others state that genre and style are two separate terms, and that secondary characteristics such as subject matter can also differentiate between genres. A music genre (or sub-genre) could be defined by the techniques, the styles, the context and the themes (content, spirit). Also, geographical origin sometimes is used to define a musical genre, though a single geographical category will normally include a wide variety of sub-genres.

In the present context, a musical genre, however it is defined, is associated with a collection of defined instruments. For example, a performance of a song in a country & western genre usually includes a violin more commonly known as a fiddle, a lead guitar, a rhythm guitar, a banjo, and a bass. Vocals generally include a lead vocalist, one or more back up vocalists, or voices singing in close harmony. Other instruments can be added including the piano, harmonica, dulcimer, washboard, cow bell, drums, etc.

The number of tracks (i.e., separate performances) of a particular song is limited only by the number of musicians and vocalists that can be arranged to perform the song or the portions thereof. As described above, a collection that includes separate tracks from more than about 5 performers requires a significant amount of storage capacity and is too large to distribute via conventional media and communication links. It has been discovered that a digitally sampled performance of a song can be substantially compressed by identifying and replaying the repetitive sub-parts of a performed song.

Once the song has been performed and recorded as a set of separate tracks as described above, an audio compression system separately analyzes each of the multiple tracks for repetitive content as shown in block 304. The analysis is performed on a sub-interval of a measure. During the performance of the song, several of the instruments will invariably repeat a previously played measure or a portion of a measure. For example, for a country & western song, a bass, a rhythm guitar, and the percussion instruments may repeat multiple measures during the course of the performance of the song. By identifying and storing a select performance of a measure that is repeated multiple times during the performance of a song for each of the separate performers or tracks, the amount of storage capacity required to provide a representation of the entire content of the performed song is significantly reduced.

Once the repetitive content is identified, the audio compression system further associates sequence identifiers with each select instance of the repetitive audio segments in the library, as shown in block 306. The sequence identifiers are used in conjunction with the audio segments to appropriately reconstruct a select track. For example, if the 4^{th} measure of a select track is repeated on the performance of the 8^{th}, 16^{th}, 32^{nd} and 64^{th} measures, and the audio segment representing the 16^{th} measure is identified as the best example of the 4^{th}, 8^{th}, 16^{th}, 32^{nd} and 64^{th} measures of the track, the 16^{th} measure is stored in the library. In addition, the sequence for the track is updated to indicate that the stored audio segment from the 16^{th} measure will be used in the 4^{th}, 8^{th}, 16^{th}, 32^{nd} and 64^{th} measures when generating a rendition of the song.

Thereafter, as shown in block 308, an interface is provided to a listener/user. The interface includes one or more controls that enable the user to select tracks from a library of the temporally compressed content representing one or more tracks from the performance of the song. The interface further includes one or more controls that enable the listener/user to adjust the playback of the one or more select tracks and/or insert a track from another source including a real-time performance of their own.

In an example embodiment (not shown), the interface is associated with a browser application that is executed on a device (e.g., a computer or a mobile device) in communication with the library. When the device is connected to a network, the library can be stored on any data storage media accessible via the network. The operator of the interface uses one or more user-selectable controls to identify a song and a genre. Additional controls may be provided to permit the operator to exclude or mute one or more of the tracks associated with the genre. Signals responsive to the user-selectable controls may be used to direct a server associated with the data store holding the library to collect and assemble identified audio segments to generate an audio stream. As briefly described above, the audio segments associated with the tracks identified by the selected genre are assembled in the order identified by the sequence identifiers of each of the selected tracks to generate the audio stream. When operating in this pre-mixed mode, the audio stream may comprise one or more tracks that have been both temporally compressed and processed by an audio encoder to achieve additional compression.

The interface can provide additional audio controls to enable the operator of the interface to further adjust one or more qualities of each of the separate tracks in the audio stream. In this example embodiment, the server may be programmed to limit the audio stream to a desired length of time before prompting the operator to make further adjustments or to enter an input indicative of the operator's desire to receive a complete rendition of the operator-mixed version of the song. Upon receipt of the input, the server may be further programmed to forward the digitally sampled version of the audio segments of the select tracks along with the operator selected manipulations to an encoder that produces an audio file in an operator identified format.

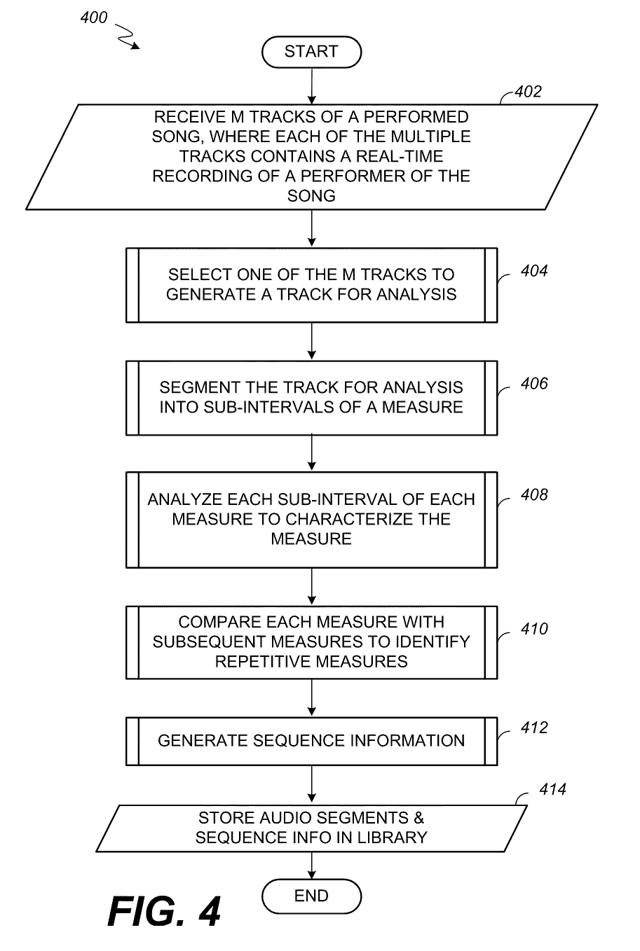

Reference is made to FIG. 4, which illustrates a flow diagram of an embodiment of a method 400 for constructing a library of pre-recorded and digitally sampled segments of a performed song. The steps illustrated in the flow diagram of FIG. 4 show the functionality and operation of an audio processing system that generates a library of digitally sampled and compressed audio tracks. In this regard, each block represents a module, segment, or portion of code, which comprises one or more executable instructions for implementing the specified function(s).

The method 400 begins with input/output block 402 where an audio compression system receives multiple tracks of a performed song, where each of the multiple tracks contains a real-time recording of a performer of the song. As described above, the information in a select track can be recorded from a single performance of an entire song or by recording separate portions of the song. Thereafter, in block 404, the audio compression system selects one of the M tracks to generate a track for analysis. In block 406, the audio compression system segments the track for analysis into sub-intervals of a measure. The sub-intervals of a measure are defined by dividing the measure by a factor of the number of beats in the measure. For example, if the song is played such that there are four beats to a measure, the measure can be broken into four, eight, sixteen or thirty-two sub-intervals.

In block 408, the audio compression system characterizes each measure of the select track. Musical content can be characterized by the frequency response of a sampled waveform, cross-correlation of sampled waveform, amplitude, etc. Musical content can be further analyzed by ear or by analyzing the musical notation that directs the performer how to perform their part of the song. In block 410, the audio compression system compares each characterized interval of the track with subsequent characterized intervals in the track to identify repetitive portions in the track. Characterized intervals may include a period of time associated with beats in a measure, a full measure, or a set of measures. Repetitive portions are associated with a unique identifier. In addition to segmenting, analyzing and identifying repetitive intervals of a select track, the audio compression system retains information identifying the number of intervals and the sequence in which the intervals were performed. Thereafter, in block 412, the audio compression system generates sequence information for each of the M tracks. As shown in input/output block 414, the unique audio segments and representative segments of repetitive content from the track are stored in the library or data store.

In some embodiments, each unique audio segment and a select or representative portion of repetitive content from each of the M tracks is stored as digitally sampled data in the library. However, when additional compression is desired, the audio compression system may forward one or more unique intervals to an encoder for additional data reduction. The output from the encoder may be stored in the library and as indicated above can be provided in an audio stream of one or more tracks during a real-time manipulation of a song.

The functions in blocks 404 through 414 can be repeated for any number of the available M tracks of the performed song. After one or more tracks have been processed by the audio compression system, the digitally sampled audio segments in the library are available for additional processing by those granted access privileges to the library and a song file. The song file includes information identifying the number of measures and the sequence in which the measures were performed. When more than one of the M tracks are processed (i.e., segmented, analyzed, compared, or otherwise processed), the song file further includes information to synchronize the recreation of the song from the component portions or measures from the multiple tracks of the performed song.

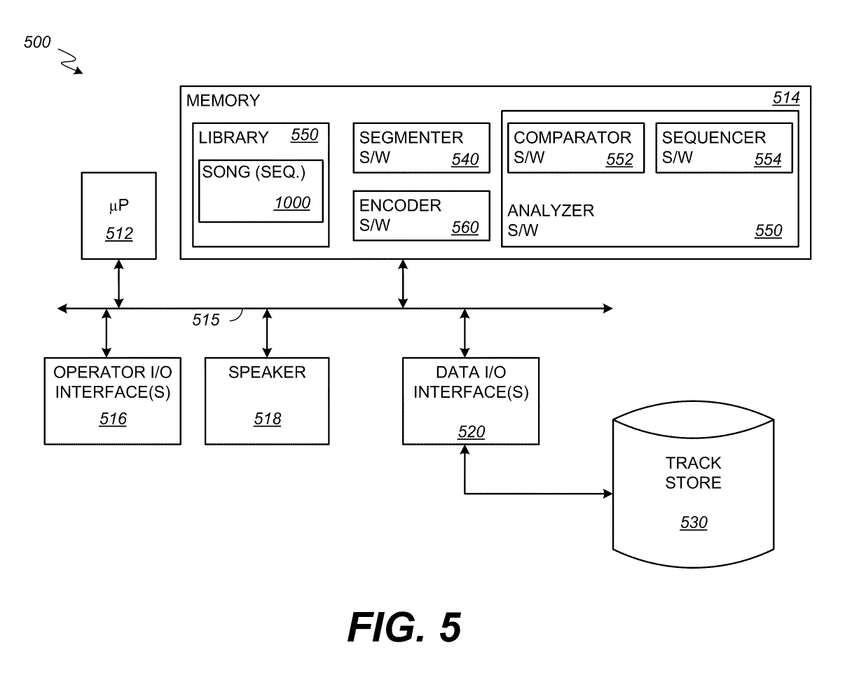

FIG. 5 is a schematic diagram illustrating an embodiment of an audio compression system 500. In the example embodiment, the audio compression system 500 includes a microprocessor or processor 512, a memory 514, operator input/output interface(s) 516, a speaker 518, and a data input/output interface 520 that are coupled to one another via a local interface 515. The data I/O interface 520 is coupled to a track store 530, which contains a set of pre-recorded tracks from the performance of a song or portions of a song.

The local interface 515 can be, for example but not limited to, one or more buses or other wired or wireless connections, as is known in the art. The local interface 515 may have additional elements, such as controllers, buffers (caches), drivers, repeaters, and receivers, to enable communications. Further, the local interface 515 may include address, control, power and/or data connections to enable appropriate communications among the aforementioned components.

The processor 512 executes software stored in the memory 514 in accordance with commands and data received via the operator I/O interfaces 516, and the data interface 520. The memory 514 includes segmenter software 540, analyzer software 550, and encoder software 560. As shown in FIG. 5, the analyzer software 550 further includes comparator software 552 and sequencer software 554.

The segmenter software 540 is a first set of executable instructions that when executed by the processor 512 segment or divide a select track from the set of M tracks of the performed song into sub-intervals of the song. In an embodiment, the segmenter software 540 segments the song into sub-intervals of a series of measures. The segmenter software 540 may operate in conjunction with a beat from a percussion instrument from one of the M tracks. Alternatively, musical notation or knowledge of the song, as entered by an operator of an input device coupled to the operator interfaces 516 can be used to set the number of segments per measure and identify the number of measures in the performed song.

The analyzer software 550 is a second set of executable instructions that when executed by the processor 512 characterize each measure of the select track by, for example, analyzing the frequency spectrum within each sub-interval of each measure. Each sound created by the performer in the select track is associated with a frequency response over the range of frequencies that are discernible by a human listener. Multiple characteristics of the frequency response for each segment or collection of segments (i.e., a measure) from the select track can be used to characterize or otherwise identify a portion of the select track.

The comparator software 552 is a third set of executable instructions that when executed by the processor 512 compare each measure of the select track, as identified by the analyzer software 550, with subsequent measures from the select track to identify measures with repetitive content. When repetitive content is identified, that is two or more measures with repetitive content can be further analyzed using a function of magnitude and timing to identify a best choice measure. A best choice measure is the one measure from the set of identified measures having repetitive content that will be further processed and stored by the audio compression system 500.

The optional encoder software 560 is a fourth set of executable instructions that when executed by the processor 512 apply an algorithm to digitally compress unique measures and a select measure (i.e., the best choice measure) from a set of measures with repetitive content from the select track. The encoder software 560 may apply an algorithm to perform any known or later developed digital compression scheme to the previously recorded measures from the M tracks. Example encoders produce digital files in WMA, MP3, MP4 and other formats. Each coded version of the unique measures and the select repetitive measure is associated with appropriate song, genre, track, and measure identifiers before being forwarded to the library 550. In an alternative embodiment, the encoder software 560 may be applied over an entire track of a performed song prior to characterizing and identifying repetitive portions or segments within the song. In another alternative embodiment, the encoder software 560 is not applied until after an operator has completed all mixing operations and communicated an intent to generate an encoded version of the operator mixed rendition of the song.

The sequencer software 554 is a fifth set of executable instructions that when executed by the processor 512 generates a representation of the pre-recorded performance of a track of the song. The sequencer software 554 generates a series of identified measures from the unique measures and measures with repetitive information that when forwarded to a player/renderer will recreate a rendition of the particular track of the song. In addition to storing audio segments for each track of a song, the library 550 also stores a song file 1000 that includes information for regenerating a rendition of the pre-recorded performance of the song. For example, the song file 1000 may include identifiers associated with a genre, a pre-recorded track, and sequence information for each track processed by the audio compression system 500. When a song is to be rendered from multiple tracks, the sequencer software 548 will have generated a corresponding series of measures for each of the multiple tracks. Moreover, as described above, a song file 1000 may include additional parameters for mixing a rendition of the song in a unique way. Such a unique rendition may include one or more adjusted tracks.

The operator I/O interface(s) 516 include logic and buffers to enable an operator to communicate with the audio compression system 500 using one or more of a keyboard, a microphone, a display, a touch-sensitive display, a multiple-function pointing and selection device such as a mouse, etc.

The operator I/O interface(s) 516 includes multiple mechanisms configured to transmit and receive information via the audio compression system 500. These mechanisms support human-to-machine (e.g., a keyboard) and machine-to-human information transfers. Such human-to-machine interfaces may include touch sensitive displays or the combination of a graphical-user interface and a controllable pointing device such as a mouse. Moreover, these mechanisms can include voice-activated interfaces that use a microphone or other transducer. In addition to a microphone, the audio compression system 500 uses speaker 518 or a set of speakers (not shown) to present an audible rendition of the original recorded tracks (or a portion thereof) as stored in the track store 530 or an audible rendition of any of the unique or repetitive measures stored in the library 550.

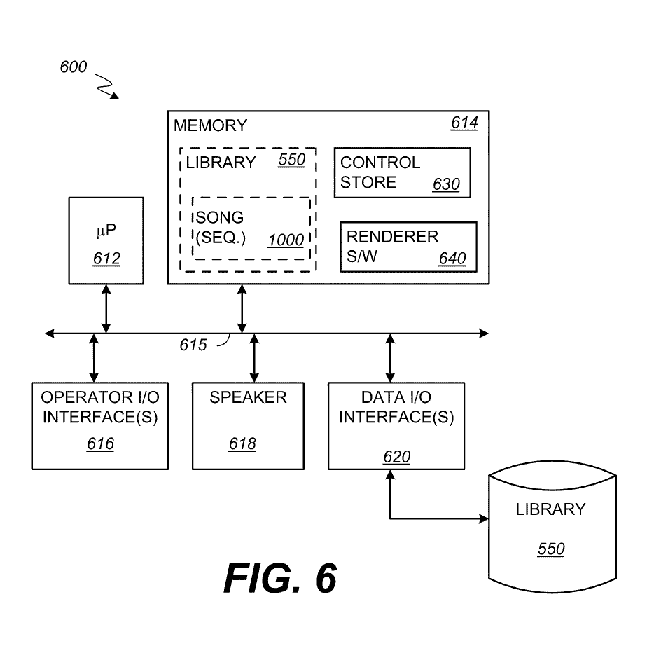

FIG. 6 is a schematic diagram illustrating an embodiment of an audio interface 600. The interface 600 is shown as a separate device than the audio compression system 500 to illustrate that these processor based devices can be separate from the other. In an alternative embodiment (not shown), the audio compression system 500 can be modified to include software from the interface 600 to expose the previously processed tracks to a user of the audio compression system 500. In the example embodiment, the audio interface 600 includes a microprocessor or processor 612, a memory 614, operator input/output interface(s) 616, a speaker 618, and a data interface 620 that are coupled to one another via a local interface 615.

The local interface 615 can be, for example but not limited to, one or more buses or other wired or wireless connections, as is known in the art. The local interface 615 may have additional elements, such as controllers, buffers (caches), drivers, repeaters, and receivers, to enable communications. Further, the local interface 615 may include address, control, power and/or data connections to enable appropriate communications among the aforementioned components.

The processor 612 executes software stored in the memory 614 in accordance with commands and data received via the operator I/O interfaces 616, and the data I/O interface 620. The memory 614 includes control store 630 and renderer software 640.

The operator I/O interface(s) 616 include logic and buffers to enable an operator to communicate with the interface 600 using one or more of a keyboard, a microphone, a display, a touch-sensitive display, a multiple-function pointing and selection device such as a mouse, etc.

The operator I/O interface(s) 616 includes multiple mechanisms configured to transmit and receive information via the interface 600. These mechanisms support human-to-machine (e.g., a keyboard) and machine-to-human information transfers. Such human-to-machine interfaces may include touch sensitive displays or the combination of a graphical-user interface and a controllable pointing device such as a mouse. Moreover, these mechanisms can include voice-activated interfaces that use a microphone or other transducer. In addition to a microphone, the interface 600 uses speaker 618 or a set of speakers (not shown) to present an audible rendition of an operator configurable rendition of the song from the previously encoded measures (both unique and repetitive) of the original recorded tracks (or a portion thereof) as stored in the library 550.

The control store 630 includes information identifying an operator selection associated with one or more operator selectable parameters for creating a unique rendition of the previously recorded song. Operator selectable parameters can be adjusted via one or more controls via the operator I/O interface(s) 616. Examples of operator selectable parameters include a song title, genre, and performers, and for each select performer, the operator may further select parameters to identify a desired pitch, relative timing, volume, reverb or other audio effect to apply to the compressed measures in the library 550. The connection between the data I/O interfaces 620 and the library 550 can include both wired and wireless portions as known in the art. The library 550 can be provided across one or more data stores in communication with the interface 600 via one or more wide area networks.

The renderer software 640 is a set of executable instructions that when executed by the processor 612 sequences and adjusts the library information representing the unique measures and the select measures from the sets of repeated measures in a subset of the M tracks of the pre-recorded song. The renderer software 640 receives one or more operator selectable parameters from the control store 630 to generate a user-defined rendition of the song.

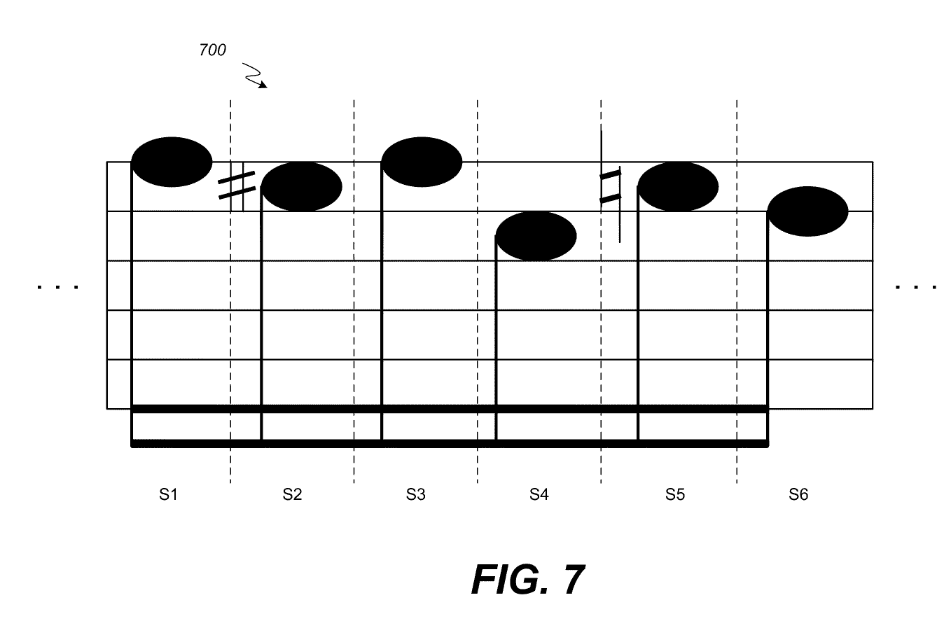

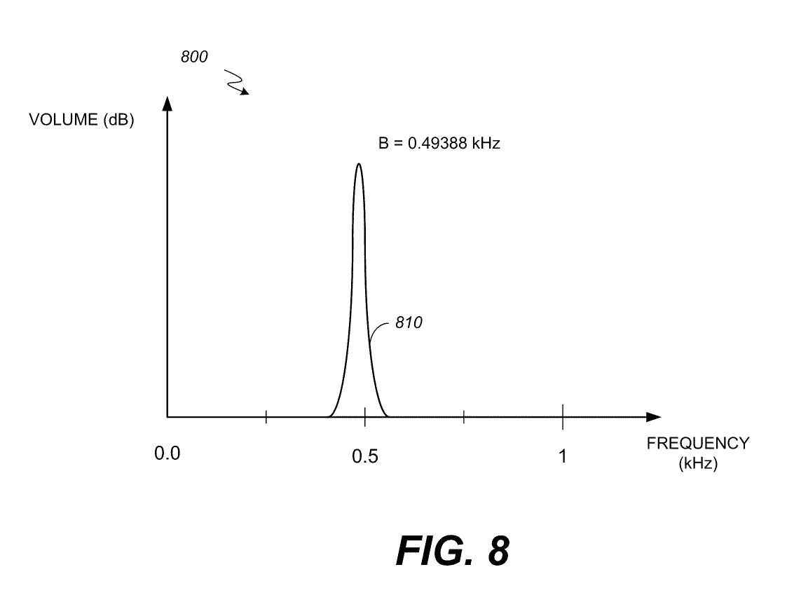

FIG. 7 is a schematic diagram illustrating the operation of an embodiment of the segmenter software 540 of FIG. 5. Illustrated in FIG. 7 is a musical notation including an example measure 700 excerpted from an arrangement of Fur Elise for trumpet in B flat. The arrangement calls for three beats per measure with every ⅛th note (i.e., a musical note having the time value of an eighth of a whole note) receiving a full beat. In the example measure 700, the segmenter software 540 has evenly segmented the measure into six separate segments. For a track recorded for an instrument that performs a single note during any one segment, the frequency analysis includes identifying the center frequency of the sound in the track. For example, FIG. 8 shows an embodiment of a frequency spectrum of a segment of a measure from a select track where the performer has played a B₄ note (i.e., the first B note above middle C or C₄ on a piano.) A B₄ note has a fundamental frequency of 493.88 Hz.

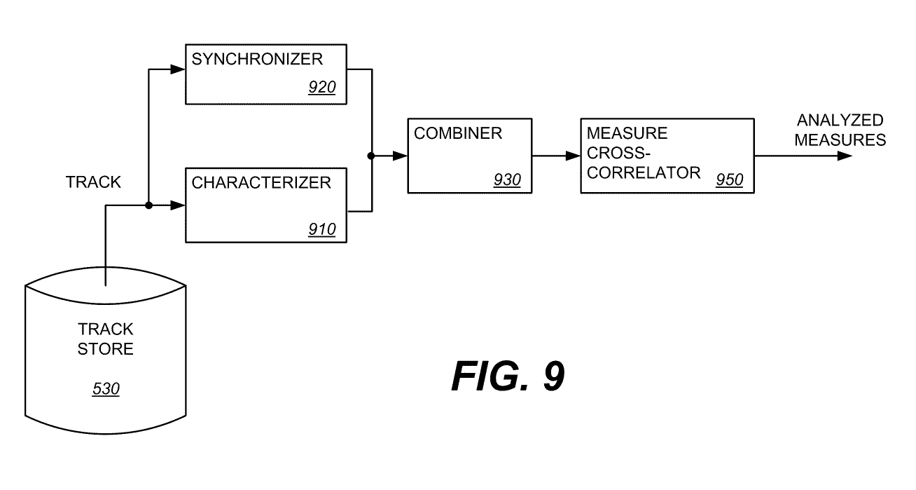

FIG. 9 is a schematic diagram illustrating the operation of an embodiment of the analyzer software 542 of FIG. 5. As shown in FIG. 9, the analysis process begins by forwarding a portion of the pre-recorded track through a characterizer 910 and a synchronizer 920. The characterizer 910 may include an instantaneous identifier of information from the sound in the track. For example, the characterizer 910 may identify one or more frequency features from the track. In another example, the characterizer 910 may perform a Mel-frequency spectral analysis to develop coefficients that describe or otherwise identify the sound in the track. The synchronizer 920 is a timer that can be adjusted relative to the track to synchronize characterization on a measure by measure basis.

The combiner 930 receives timing information from the synchronizer 920 and frequency information from the characterizer 910 and forwards synchronized information identifying the content of the measure to a measure cross-correlator 950. The measure cross-correlator 950 includes a buffer for temporarily storing synchronized frequency information from previously characterized measures. The measure cross-correlator 950 identifies separate measures from within the track that include substantially the same content. The analyzed instances of measures with repetitive content are associated for additional analysis to identify a select measure to be used when rendering the song.

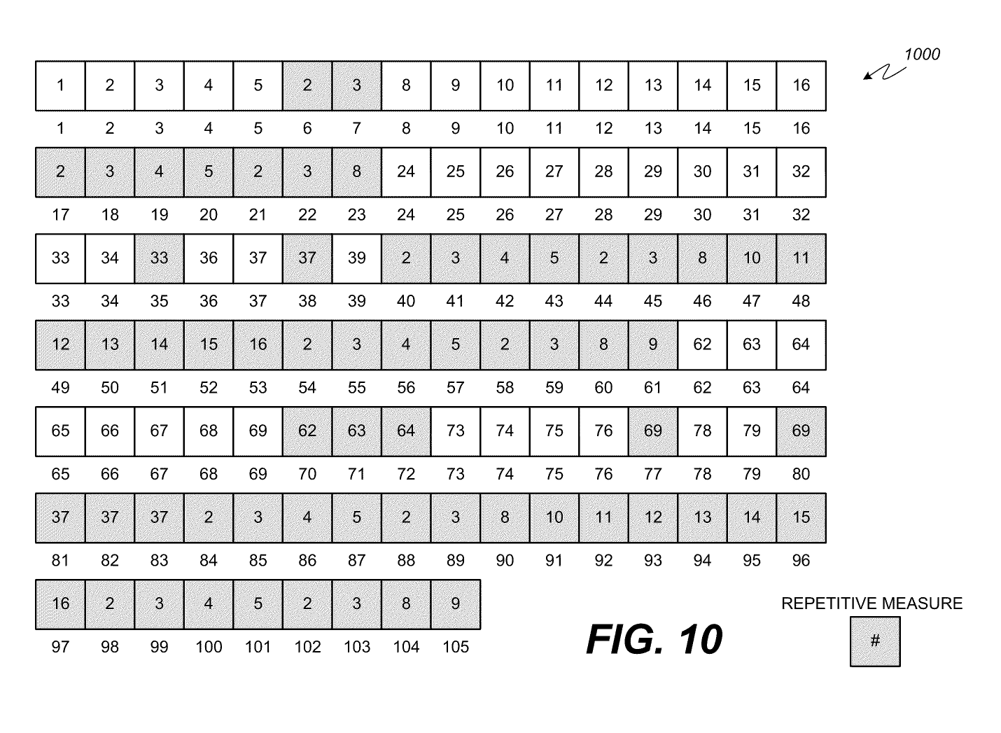

FIG. 10 is a schematic diagram illustrating the operation of an embodiment of the sequencer software 548 of FIG. 5. More specifically, FIG. 10 shows a song sequence 1000 as a series of measures for the song Fur Elise by Ludwig van Beethoven, as arranged by Andy Ralls, for trumpet in B flat. Sheet music for this arrangement can be found at http://www.mfiles.co.uk. Each square represents a single measure for the trumpet player to perform. As shown by the sequentially ordered numbers 1 through 105, there are 105 measures in the example arrangement of Fur Elise. Of the 105 measures, those that are shown in light grey represent repetitive measures from the arrangement. For example, the sixth and seventh sequential measures are repeats of the notes performed in measures 2 and 3 respectively. The numerals inside each square represent the first instance of the notes performed within the measure. Careful observation of FIG. 10 will show that a substantial portion of the trumpet performance for the example arrangement can be compressed (i.e., removed) by selecting one of the pre-recorded and sampled instances for a similar measure and storing only the select measure. For example, sixty-three measures of the one-hundred five measures of the arrangement include repetitive measures. That is, over one-half of the measures for this performer can be replaced by a previously recorded measure. Upon further inspection, some measures provide for additional compression. For example, the second measure of the arrangement is repeated eleven times across the song.

Various aspects, features and characteristics of the present invention have been described. Not all of the aspects, features or characteristics are required for each and every embodiment of the present invention. However, it will be appreciated that the various aspects, features, characteristics and combinations thereof may be considered novel in and of themselves.

1. A method for constructing a library of pre-recorded audio segments of a song, the method comprising:
receiving M tracks of a performed song, the M tracks including a real time recording of a select performer of the song;
selecting one of the M tracks to generate a select track for analysis;
segmenting the select track into sub-intervals of a measure, the song containing a series of measures;
analyzing each sub-interval of each measure in the series of measures of the select track to characterize the measure;
comparing each measure with subsequent measures of the select track to identify repetitive measures;
identifying a select measure from a set of repeated measures from the select track; and
storing the select measure from a corresponding set of repeated measures in the library.

2. The method of claim 1, wherein receiving M tracks of a performed song includes a first subset of tracks in which the song is performed in a first musical genre and at least one additional subset of tracks in which the song is performed in a second musical genre that is different from the first musical genre.

3. The method of claim 2, wherein the first subset of tracks performed in a first musical genre identifies a first collection of instruments and wherein the second subset of tracks performed in a second musical genre identifies a second collection of instruments.

4. The method of claim 1, further comprising:
selecting a subsequent track; and
repeating the segmenting, analyzing, comparing, using, and storing steps to generate a representation of the subsequent track.

5. The method of claim 1, wherein segmenting the select track into sub-intervals of a measure comprises dividing the measure by a factor of the number of beats in the measure.

6. The method of claim 1, further comprising:
associating a sequential identifier with each of the unique measures and each of the select measures from the sets of repeated measures.

7. The method of claim 1, wherein comparing each measure with subsequent measures of the select track to identify repetitive measures comprises cross-correlating the frequency spectrum of each measure with that of the subsequent measures.

8. The method of claim 1, wherein using a coder to digitally compress a select measure from a set of repeated measures from the select track comprises identifying a measure that includes the loudest and most accurate in time of the measures in a set of repeated measures.

9. A system, comprising:
a processor having access to M tracks of a performed song, the M tracks including a real time recording of a select performer;
a memory coupled to the processor via a local interface, the memory including:
a first set of executable instructions that when executed by the processor segment a select track from the set of M tracks of the performed song into sub-intervals of a measure, the song containing a series of measures;
a second set of executable instructions that when executed by the processor characterize each measure of the select track by analyzing each sub-interval of each measure;
a third set of executable instructions that when executed by the processor compare each measure of the select track with subsequent measures from the select track to identify measures with repetitive content; and
a fourth set of executable instructions that when executed by the processor apply an algorithm to identify a select measure from a set of measures with repetitive content from the select track.

10. The system of claim 9, further comprising a library of the select measures from sets of repetitive content from the select track.

11. The system of claim 9, wherein the M tracks of a performed song include a first subset of tracks in which the song is performed in a first musical genre and at least one additional subset of tracks in which the song is performed in a second musical genre that is different from the first musical genre.

12. The system of claim 11, wherein the first subset of tracks performed in a first musical genre identifies a first collection of instruments and wherein the second subset of tracks performed in a second musical genre identifies a second collection of instruments.

13. The system of claim 9, wherein the first set of executable instructions divides the measure by a factor of the number of beats in the measure.

14. The system of claim 9, wherein one of the first set of executable instructions and the second set of executable instructions associates a sequential identifier with each unique measure and each of the select measures from the sets of repeated measures.

15. The system of claim 9, wherein the third set of executable instructions cross-correlates the frequency spectrum of each measure with that of subsequent measures.

16. The system of claim 9, wherein the fourth set of executable instructions identify a measure that includes the loudest and most accurate in time of the measures in a set of repeated measures.

17. An interface, comprising:
a processor having access to a library of digitally sampled representations of unique measures and select measures from sets of repeated measures in M tracks of a pre-recorded real time performance of a song, wherein each of the M tracks includes a recording of a select performer;
a memory coupled to the processor, the memory including:
a control store having information associated with one or more user selectable parameters; and
a set of executable instructions that when executed by the processor sequences and adjusts the library information representing the unique measures and the select measures from the sets of repeated measures in a subset of the M tracks of the pre-recorded song in accordance with the one or more operator selectable parameters to generate a user-defined rendition of the song.

18. The interface of claim 17, wherein the one or more user selectable parameters is selectable from the group consisting of genre, pitch, relative timing, volume, spatial position, timbre, chorus, distortion, and reverb.

19. The interface of claim 17, wherein the set of executable instructions enable the user to remove a select performer from the user-defined rendition of the song.

20. The interface of claim 17, wherein the set of executable instructions enable the user to mix the song.
